(19) United States
(12) Patent Application Publication
(10) Pub. No.: US 2025/0326461 A1
(43) Pub. Date: Oct. 23, 2025

(54) DRIVER FOR TRANSFERRING TORQUE FROM A SET OF SPROCKETS OF DIFFERING NUMBER OF TEETH TO A WHEEL OF A BICYCLE

(71) Applicant: CLASSIFIED CYCLING BV, Antwerpen (BE)

(72) Inventors: Roëll Marie VAN DRUTEN, Eindhoven (NL); Johannes Gijsbertus Antonius VAN DEN BRAND, Nuenen (NL)

(21) Appl. No.: 18/962,303

(22) Filed: Nov. 27, 2024

(30) Foreign Application Priority Data
Nov. 28, 2023 (NL) 2036371

(51) Int. Cl. B62M 9/10; B60B 27/04

(52) U.S. Cl. CPC B62M 9/10; B60B 27/04

(57) ABSTRACT

The disclosure relates to a driver for transferring torque from a set of sprockets of differing number of teeth to a wheel of a bicycle. The driver has a rotation axis and comprises a coupling profile for coupling the set of sprockets thereto. The coupling profile includes a first support structure and a further support structure. The first support profile is arranged at a first radius from the rotation axis, and is configured for carrying the smallest sprocket of the set of sprockets and supporting the set of sprockets in only a radial direction. The further support structure is arranged at a further radius from the rotation axis larger than the first radius, and is configured for supporting the set of sprockets in a tangential direction.

### FIELD

The disclosure relates to a driver for a bicycle, configured to receive a set of sprockets and transfer torque from the set of sprockets to a wheel of the bicycle.

### BACKGROUND

Wheel assemblies for a driven wheel of a bicycle typically include a driver for mounting a set of sprockets. The driver is coupled to a hub of wheel assembly for transferring torque from the set of sprockets to the hub. A freewheeling mechanism is generally provided between the driver and the hub, permitting torque to be transmitted in the one direction of rotation (the forward driving direction), whereas the driver is rotationally decoupled from the hub in the opposing direction of rotation from the rear wheel hub.

By means of a derailleur a chain can be shifted to thread over a selective sprocket of the set, to change a transmission ratio of the bicycle transmission. A set of sprockets are often interchangeable. Conventional systems comprise a cylindrical shaped driver provided with axial splines, wherein a set of sprockets can be axially slid onto the driver and be axially locked by a locking element that typically threadingly couples to the driver. The axial splines support the set of sprockets in tangential direction to transfer torque about a rotation axis of the driver, corresponding to a rotation axis of the bicycle wheel.

Contemporary systems, which include an internal transmission housed in part by the driver, may include non-cylindrical drivers. An example of such non-cylindrical driver is for instance disclosed in WO2017/039442, having a coupling profile for coupling a set of sprockets thereto. The coupling profile includes different interfaces at different ratios for supporting the set of sprockets.

### SUMMARY

It is an object to propose a driver, particularly for bicycles that include internal hub transmission, with an improved coupling profile for coupling to a set of sprockets. It is particularly an aim to provide a driver configured for receiving a wide variety of different sets of sprockets. It is furthermore an aim to facilitate exchanging sets of sprocket for a user. In a more general sense it is an object to overcome or reduce at least one of the disadvantages of the prior art. Alternatively, it is an object to at least provide a useful alternative.

An aspect provides a driver for transferring torque from a set of sprockets of differing number of teeth to a wheel of a bicycle. The driver has a rotation axis and comprises a coupling profile for coupling the set of sprockets thereto. The rotation axis in use corresponds to the rotation axis of the bicycle wheel. The coupling profile includes a first support structure and a further support structure. The first support structure is arranged at a first outer radius from the rotation axis. The first support structure is configured for carrying the smallest sprocket of the set of sprockets. The first support structure is configured for supporting the set of sprockets in only a radial direction and/or an axial direction. The further support structure is arranged at a further radius from the rotation axis larger than the first radius, and is configured for supporting the set of sprockets in a tangential direction. The further support structure may include, or be, one or more of a second support structure, a third support structure, and a fourth support structure as described herein. The further support structure may be spaced in axial direction from the first support structure. Preferably, a smallest outer radius at the axial location of the further support structure is larger than the first outer radius. Hence, tangential support of the set of sprockets, for transferring torque from the set of sprockets to the driver, is provided at a location where material is present continuously circumferentially at a radius larger than the first radius. Thus, torque can be transferred at a location of the further support structure where the driver is stronger than at a location of the first support structure. Such strength is not required at the first support structure, seen that the first support structure only needs to carry the smallest sprocket of the set of sprockets, and support the set of sprockets in only the radial direction and/or the axial direction.

Optionally, the driver comprises one or more bearings, such as one or more roller bearings, for supporting the driver onto a wheel axle. The driver can comprise one or more bearing mounting surfaces for mounting the one or more bearings. The one or more bearing mounting surfaces can each include an internal cylindrical surface of the driver.

Optionally, the first support structure is positioned axially spaced from the one or more bearings. Optionally, the first support structure is positioned axially offset towards the drive side, relative to the drive side bearing of the one or more bearings. Optionally, the first support structure is positioned axially spaced from the one or more bearing mounting surfaces. Optionally, the first support structure is positioned axially offset towards the drive side, relative to the drive side bearing mounting surface of the one or more bearing mounting surfaces.

Optionally, the first outer radius is smaller than an outer radius of at least one of the one or more bearings. Preferably, the first outer radius is smaller than an outer radius of the drive side bearing of the one or more bearings. Optionally, the first outer radius is smaller than an inner radius of at least one of the one or more bearing mounting surfaces. Preferably, the first outer radius is smaller than an inner radius of the drive side bearing mounting surface of the one or more bearing mounting surfaces.

Optionally, the further support structure is axially positioned at the location of at least one of the one or more bearings, or between the one or more bearings. Preferably, the smallest outer radius at the axial location of the further support structure is larger than the outer radius of at least one of the one or more bearings. Optionally, the further support structure is axially positioned at the location of at least one of the one or more bearing mounting surfaces, or between the one or more bearing mounting surfaces. Preferably, the smallest outer radius at the axial location of the further support structure is larger than the inner radius of at least one of the one or more bearing mounting surfaces.

Optionally, the driver is arranged such that the one or more bearings are mounted from the non-drive side. Mounting the bearings from the non-drive side allows the first support structure to be positioned axially offset towards the drive side, relative to the drive side bearing of the one or more bearings.

Optionally, the first support structure has a first cylindrical inner surface associated therewith at the axial position of the first support structure. Optionally, an inner diameter of the first cylindrical inner surface is smaller than the inner diameter of at least one of the one or more bearing mounting surfaces. Preferably, the inner diameter of the first cylindrical inner surface is smaller than the inner diameter of the drive side bearing mounting surface of the one or more bearing mounting surfaces.

Preferably, the smallest sprocket of the set of sprockets has at most 11 teeth, or at most 10 teeth. Such sprocket cannot be radially supported on a conventional driver. In conventional drivers, the outer diameter of the drive side bearing is too large to allow radially supporting the sprocket having at most 11, or at most 10 teeth, on the driver. However, the driver having some or all of the features disclosed herein, allow radial support of the sprocket having at most 11, or at most 10 teeth, on the driver.

The first support structure is hence configured to exclusively support the set of sprockets in one or both of the radial direction and the axial direction. The first support structure can hence be configured to support the set of sprockets exclusively in the radial direction. The first support structure can hence be configured to support the set of sprockets exclusively in the axial direction. The first support structure can hence be configured to support the set of sprockets in the radial direction and in the axial direction only. The first support structure can hence be configured to not support the set of sprockets in the tangential direction. Therefore, no torque is transferrable from the set of sprockets to the driver via the first support structure. Instead, torque can be transferred from the set of sprockets to the driver via the further support structure. The first support structure can carry the smallest sprocket of the set, i.e. support the smallest sprocket radially. The smallest sprocket of the set carried by the first support structure can transfer torque via adjacent sprockets to the second support structure. It will be appreciated that the driver may be coupled to various sets of sprockets.

The first support structure may be arranged at an axial end of the driver. By radially supporting the smallest sprocket of the set, a robust and durable coupling can be obtained between the set of sprockets and the driver, particularly since the smallest sprocket is radially well defined prior to axially locking the set of sprockets axially. This furthermore facilitates coupling and decoupling of the set of sprockets and axially locking the set to the driver, as the one or more smallest sprockets are not self-supporting and therefore less prone to misalignments.

The aspect may hence provide a driver for transferring torque from a set of sprockets of differing number of teeth to a wheel of a bicycle, the driver has a rotation axis and comprising a coupling profile for coupling the set of sprockets thereto, wherein the coupling profile includes a first support profile arranged at a first radius from the rotation axis, and configured for carrying the smallest sprocket of the set of sprockets and not support the set of sprockets in the tangential direction.

It will be appreciated that this aspect may include some or all of the options and features of the aspects to be described hereinbelow.

An aspect provides a driver, such as described herein, for transferring torque from a set of sprockets of differing number of teeth to a wheel of a bicycle, comprising a coupling profile for coupling the set of sprockets thereto, and a thread, particularly an internal thread, for cooperating with a locking element, wherein the, e.g. internal, thread has a nominal diameter of at most 26 mm, particularly at most 25 mm. The, e.g. internal, thread of the driver may for example be in accordance with a standard M25 threads.

The internal thread can have a smallest diameter which is smaller than an inner diameter of at least one of the one or more bearing mounting surfaces. Preferably, the internal thread can have a smallest diameter which is smaller than an inner diameter of the drive side bearing mounting surface of the one or more bearing mounting surfaces. The internal thread can be axially offset relative to the drive side bearing mounting surface. A particular aspect provides a driver, such as described herein, for transferring torque from a set of sprockets to a wheel of a bicycle, the driver having a rotation axis and comprising a coupling profile for coupling the set of sprockets thereto, wherein the coupling profile includes a first support structure at a first radius from the rotation axis, configured for supporting the set of sprockets in only a radial direction; a second support structure at a second radius from the rotation axis, larger than the first radius, configured for supporting the set of sprockets in only the radial direction and a tangential direction; a third support structure at a third radius from the rotation axis, larger than the second radius, configured for supporting the set of sprockets in only an axial direction; and a fourth support structure at a fourth radius from the rotation axis, larger than the third radius, configured for supporting the set of sprockets in only the radial direction and the tangential direction. The first, second, third and fourth support structures may be spaced apart from each other in axial direction. Preferably, a smallest outer radius at the axial location of the second, third and fourth support structures is larger than the first outer radius.

An aspect provides a driver for transferring torque from a set of sprockets to a wheel of a bicycle, the driver having a rotation axis and comprising a coupling profile for coupling the set of sprockets thereto, wherein the coupling profile includes a first adapter support surface and a second adapter support surface, each configured for supporting respectively a first adapter and a second adapter in a radial direction, wherein the first adapter support surface is at a smaller radius from the rotation axis than the second adapter support surface. The first adapter support surface and the second adapter support surface may particularly configured to respectively supporting the first adapter and the second adapter only in the radial direction.

An aspect provides an assembly comprising a driver for transferring torque from a set of sprockets to a wheel of a bicycle, the driver having a rotation axis and comprising a coupling profile for coupling the set of sprockets thereto, wherein the coupling profile includes a first adapter support surface and a second adapter support surface, each configured for supporting respectively a first adapter and a second adapter in a radial direction, wherein the first adapter support surface is at a smaller radius from the rotation axis than the second adapter support surface. The assembly in a first configuration comprises the first adapter supported by the first adapter support surface, and the assembly in a second configuration comprises the second adapter supported by the second adapter support surface. The assembly in the first configuration may be configured for supporting a first set of sprockets and wherein the assembly in the second configuration is configured for supporting a second set of sprockets different from the first set of sprockets.

An aspect provides an assembly, comprising a set of sprockets with differing number of teeth, wherein the smallest sprockets of the set forms a unitary subset of sprockets so fixed to each other to move monolithically, the unitary subset including a smallest sprocket of the set of sprockets having at most 11 teeth, or at most 10 teeth; and a driver such described herein for transferring torque to a wheel of a bicycle, the driver having a rotation axis and comprising a coupling profile for coupling the set of sprockets thereto, wherein the coupling profile includes a first support structure at a first radius from the rotation axis, configured for supporting the unitary subset in only a radial direction.

An aspect provides an assembly comprising a driver such as described herein for transferring torque in a forward drive direction from a set of sprockets with differing number of teeth to a wheel of a bicycle, and an adapter for being coupled to the driver, the driver comprising a rotation axis and a coupling profile having a second support structure with second axial splines configured for supporting the set of sprockets in at least a tangential direction; and the adapter releasably coupled to the driver, and including first axial splines, wherein a coupling interface between the driver and the adapter is configured such that, in a coupled state, the first axial splines and the second axial splines are respectively aligned. With the adapter, the driver can made compatible with a larger range of different sets of sprockets.

An aspect provides an assembly comprising a driver such as described herein for transferring torque in a forward drive direction from a set of sprockets with differing number of teeth to a wheel of a bicycle, and an adapter for being coupled to the driver, the driver comprising a rotation axis and a coupling profile having a support structure, such as the second support structure described herein, configured for supporting the set of sprockets in at least a tangential direction; and the adapter being configured to be releasably coupled to the driver, wherein a coupling interface between the driver and the adapter is configured to not transfer torque from the adapter to the driver in the forward drive direction. Hence, the set of sprockets may be carried by the adapter, and e.g. supported radially, while torque may only transferrable from those sprockets carried by the adapter to the driver via adjacent sprockets of the set. This allows for an even load distribution on the driver.

An aspect provides an assembly, comprising a set of sprockets with differing number of teeth; and a driver such as described herein for transferring torque from the set of sprockets to a wheel of a bicycle in a forward drive direction, the driver having a rotation axis and comprising a coupling profile for coupling the set of sprockets thereto. The coupling profile includes a second support structure at a second radius from the rotation axis, configured for supporting the set of sprockets in only the radial direction and a tangential direction, and a fourth support structure at a fourth radius from the rotation axis, larger than the second radius, configured for supporting the set of sprockets in only the radial direction and the tangential direction; wherein the set of sprockets is coupled to the driver, overlapping the second support structure and the fourth support structure, such the set of sprockets is supported by the driver in tangential direction only by the fourth support structure. Despite that the driver may have two tangential support structures, it may be preferable to only transfer torque at one of the tangential support structures, such as only at the tangential support structure at the largest radius from the rotation axis. The second support structure may thus not carry the set of sprockets. The second support structure may thus be bypassed.

An aspect provides a set of sprockets comprising a plurality of sprockets with differing numbers of teeth configured for being supported by a driver as described herein.

An aspect provides an assembly comprising a driver such as described herein for transferring torque about a rotation axis to a wheel of a bicycle and configured for being coupled to a first set of sprockets and a second, different, set of sprockets, wherein the assembly in a first configuration comprises a first locking element coupled to the driver to axially engage the smallest sprocket of the first set of sprockets to axially lock the first set of sprockets, and wherein the assembly in a second configuration comprises a second locking element, different from the first locking element, coupled to the driver to engage a smallest sprocket of a second, different, set of sprockets to axially lock the second set of sprockets. An aspect provides an assembly, comprising a driver such as described herein for transferring torque about a rotation axis to a wheel of a bicycle and configured for being coupled to a first set of sprockets with differing number of teeth including a smallest sprocket having at most 10 teeth, wherein the assembly in a first configuration comprises a first locking element coupled to the driver for axially engaging the smallest sprocket of the first set of sprockets to axially lock the first set of sprockets, and wherein the assembly in a second configuration comprises an adapter releasably coupled to the driver, such that the driver can support a second set of sprockets with differing number of teeth including a smallest sprocket having 11 teeth or more, and a second locking element, different from the first locking element, releasably coupled to the driver for engaging the smallest sprocket of the second set of sprockets to axially lock the second set of sprockets.

An aspect provides an assembly comprising a driver, such as described herein, for transferring torque from a set of sprockets of differing number of teeth to a wheel of a bicycle, the driver comprising a coupling profile for coupling the set of sprockets thereto, and an external thread; and wherein the assembly comprises a locking element having an internal thread for cooperating with the external thread of the driver, wherein the locking element forms at its radial exterior a first support structure arranged at a first radius from the rotation axis, configured for carrying the smallest sprocket of the set of sprockets and supporting the set of sprockets in only a radial direction and/or an axial direction. The external thread of the driver may for example be in accordance with a standard M25 threads. An aspect provides a hub assembly for a bicycle wheel comprising a hub and a driver as described herein connected to the hub, optionally via an internal transmission housed at least partly by the driver. The transmission may for instance include a planetary gear set having an input for being connected to the driver and an output for being connected to the hub. An aspect provides a bicycle comprising a driver as described herein.

The features and options described hereinbelow can apply to any of the above described aspects. It will be appreciated that an optional feature described hereinbelow, is not optional for those aspects described hereinabove where the same feature is explicitly defined as being included.

Optionally, the first radius is less than 16 mm, such as between 12 and 17 mm, preferably between 14 mm and 16 mm, more preferably approximately 15 mm. The first support structure may hence have an outer diameter of less than 32 mm, such as between 25 and 32 mm, preferably between 27 mm and 31 mm, more preferably approximately 30 mm.

Optionally, the smallest sprocket has at most 11 teeth, or at most 10 teeth.

Optionally, the first support structure is free of splines.

Optionally, the first support structure is arranged at an axial end of the driver, and the driver comprises at the axial end a thread for cooperating with a complementary thread of a locking element. Optionally, the driver includes an internal thread for cooperating with an external thread of the locking element. Optionally, the driver includes an external thread for cooperating with an internal thread of the locking element. Optionally, a nominal diameter of the, e.g. internal, thread is at most 26 mm, preferably at most 25 mm. The thread of the driver may for example be in accordance with a standard M25 threads.

Optionally, the smallest sprocket together with at least a second smallest sprocket of the set forms a unitary subset of sprockets so fixed to each other to move monolithically. A unitary sprocket subset includes multiple sprockets that are fixed to each other in a durable manner, also when separate from the driver. The sprockets of a unitary subset may for example be machined from a single block of material, or may include sprockets that are durably mounted to each other.

Optionally, the unitary subset includes a third smallest sprocket of the set.

Optionally, the further support structure includes or is a second support structure at a second radius from the rotation axis larger than the first radius.

Optionally, the second support structure is configured for supporting set of sprockets in a tangential direction and a radial direction.

Optionally, the coupling profile is configured to not support the set of sprockets in axial direction by the second support structure.

Optionally, the second support structure comprises one or more splines. A smallest outer radius of the second support structure, at the base of the one or more splines, can be larger than the first outer radius.

Optionally, the second support structure comprises axial splines, each extending lengthwise parallel to the rotation axis.

Optionally, the axial splines extend lengthwise from a first end proximate the first support structure to a second end distal to the first support structure, and wherein one or more of the axial splines have a first width at the first end and a second width at the second end, the first width being smaller than the second width. A varying width allows the driver to be coupled to e.g. an adapter, particularly such that the axial splines are extended by the adapter. It will be appreciated that a length of the axial splines corresponds to an axial dimension of the axial splines and that the width corresponds to a dimension transverse to the length, particular in a tangential direction.

Optionally, said one or more of the axial splines are recessed at the first end.

Optionally, the axial splines each include a drive side configured to transfer torque to the driver in a forward drive direction, and a non-drive side opposite the drive side, and wherein the non-drive side of one or more of the axial splines is recessed at an axial end of said one or more axial splines proximate the first support structure. Bicycles are generally not driven in reverse, such that little to no torque needs to be transferred through the non-drive side of the axial splines in practice. Some bicycles for example include a freewheel mechanism between the bicycle wheel and the driver, to allow the driver to be rotated backwards without transferring torque to the bicycle wheel. Hence, in practice, the non-drive side of the axial splines is loaded less frequent, and to lesser extent than the drive side. By providing the recesses at the non-drive side, no torque is transferrable from the adapter to the driver in the forward drive direction. Torque is accordingly transferred through those sprockets of the set that are carried by the second support structure, thus providing an even load distribution over the drive-sides of the axial splines.

Optionally, a lengthwise dimension of the axial splines is at most 10 mm, preferably in a range between 1 and 8 mm, more preferably in a range between 3 and 6 mm.

Optionally, the further support structure includes or is a third support structure at a third radius from the rotation axis, larger than the first radius, and preferably larger than the second radius. The third support structure may be configured for supporting a sprocket of the set of sprockets in an axial direction, particularly exclusively in the axial direction. Hence, the third support structure may be configured for not supporting the set of sprockets in the tangential and radial direction.

Optionally, the second radius is in a range of 30 to 35 mm, such as between 32 and 34 mm.

Optionally, the coupling profile is configured to only support the set of sprockets in the axial direction with the third support structure. Hence, the set of sprockets can be statically determinate in axial direction.

Optionally, the coupling profile is configured to only support the set of sprockets in the axial direction with the first support structure.

Optionally, the coupling profile is configured to only support the set of sprockets in the axial direction with the second support structure.

Optionally, the coupling profile is configured to only support the set of sprockets in the axial direction with the fourth support structure.

Optionally, the third support structure comprises an axial abutment surface to axially abut a sprocket of the set of sprocket.

Optionally, the axial abutment surface faces in axial direction, particularly towards the first axial end of the driver, is annular shaped and coaxial with the rotation axis. The annular shape allows for even distribution of axial loading forces over the axial abutment surface.

Optionally, the further support structure includes, or is, a fourth support structure at a fourth radius from the rotation axis, larger than the first radius, and preferably larger than the second radius and preferably larger than the third radius, configured for supporting a sprocket of the set of sprockets in only the radial direction and a tangential direction.

Optionally, the fourth support structure comprises a plurality of axial spline pairs, the splines of each pair being angularly spaced apart for accommodating a complementary support structure of a sprocket, wherein the spline pairs are angularly spaced apart by a distance larger than the angular spacing between the splines of the pairs.

Optionally, the fourth support structure comprises six spline pairs, e.g. angularly regularly spaced at 60 degrees intervals.

Optionally, the spacing between splines of each spline pair may be between 3 and 5 mm, such as approximately 4 mm.

Optionally, the coupling interface between the driver and the adapter is arranged for providing a form-closed coupling between the driver and the adapter.

Optionally, the coupling interface between the driver and the adapter is configured to not transfer torque in the forward drive direction.

Optionally, the coupling interface between the driver and the adapter is configured for transferring torque from the adapter to the driver in only one rotation direction about the rotation axis.

Optionally, the coupling interface between the driver and the adapter is configured to transfer torque only in a backward direction of the driver, e.g. a freewheel direction, opposite the forward drive direction.

Optionally, the coupling profile comprises a first support structure at a smaller radius from the rotation axis than the second support structure, the first interface being configured for supporting the set of sprockets, particularly carrying a smallest sprocket of the set of sprockets, in only a radial direction.

Optionally, the adapter is carried by the first support structure, for supporting the set of sprockets with the adapter.

Optionally, the first support structure supports the adapter only in the radial direction.

Optionally, the adapter is omittable from the assembly to expose the first support structure for enabling the first support structure to support the set of sprockets, particularly a smallest sprocket of the set of sprockets.

Optionally, an axial extent of the first splines is larger than an axial extent of the second splines. The first splines may for example have a length within a range of between 10 and 15 mm, such as approximately 12 mm. The second splines may for example have a length within a range of between 2 and 5 mm, such as approximately 3 or 4 mm.

Optionally, the first and/or second axial splines have a depth of approximately 2 mm. It will be appreciated that a length of the axial splines corresponds to an axial dimension of the axial splines and that the depth corresponds to a dimension transverse to the length, particular in a radial direction.

Optionally, the second support structure includes between 6 and 12 axial splines, such as between 8 and 10 axial splines, such as 9 axial splines. Optionally, the adapter includes an equal number of axial splines as the second support structure.

Optionally, in the coupled state, the combined axial extent of the first and second axial splines is in a range between 10 and 20 mm, preferably in a range between 12 and 17 mm, such as approximately 15 mm.

Optionally, in the coupled state, the adapter extends in the axial direction beyond the driver.

Optionally, the assembly comprises the set of sprockets. The sprockets may be coupled to the driver and the adapter.

Optionally, the set of sprockets is coupled to the driver, overlapping the second support structure and at least partly carried by the adapter, wherein the set of sprockets is not supported by the second support structure in tangential direction.

Optionally, the second support structure is at a second radius from the rotation axis and the coupling profile comprises a first support structure at a first radius from the rotation axis, smaller than the second radius, the adapter being supported by the first support structure in only a radial direction.

Optionally, the adapter described herein may be a first adapter or a second adapter. The adapter may hence have a radius corresponding to a radius of the first adapter support surface. The adapter may also have a radius corresponding to a radius of the second adapter support surface.

Optionally, any of the first and second adapter support surfaces corresponds to any surface of any of the support structures of the driver. For example, the first adapter support surface may correspond to a surface of one of the first, second, third or fourth support structure. The first adapter support surface may particularly correspond to a surface of the first support structure. The second adapter support surface may particularly correspond to a surface of the second support structure.

Optionally, the coupling profile comprises a fourth support structure at a fourth radius from the rotation axis, larger than the second radius, configured for supporting the set of sprockets in the tangential direction; wherein the set of sprockets is coupled to the driver, overlapping the second support structure and the fourth support structure, such the set of sprockets is supported by the driver in tangential direction only by the fourth support structure.

Optionally, the fourth radius is larger than 35 mm.

Optionally, the set of sprockets comprises a complementary first support structure at the first radius from the rotation axis for cooperating with the first support structure of the driver, and/or a complementary second support structure at the second radius from the rotation axis for cooperating with the second support structure of the driver, and/or a complementary third support structure at the third radius from the rotation axis for cooperating with the third support structure, and/or a complementary fourth support structure at the fourth radius from the rotation axis for cooperating with the fourth support structure.

Optionally, the set of sprockets includes ten, eleven, twelve, thirteen, fourteen or fifteen differently sized sprockets.

Optionally, the set of sprockets comprises a first unitary sprocket subset and a second unitary sprocket subset each including a respective multiple of sprockets being so fixed to one another to move monolithically, wherein the first unitary sprocket subset comprises a complementary first support structure for cooperating with the first support structure of the driver, and a complementary second support structure for cooperating with the second support structure of the driver, and wherein the second unitary sprocket subset comprises a complementary second support structure for cooperating with the second support structure of the driver.

Optionally, the second unitary sprocket subset comprises a complementary third support structure configured for cooperating with the third support structure of the driver.

Optionally, second unitary sprocket subset comprises a complementary fourth support structure configured for cooperating with the fourth support structure of the driver.

Optionally, the set of sprockets comprises a third unitary sprocket subset and a fourth unitary sprocket subset each including a respective multiple of sprockets being so fixed to one another to move monolithically, wherein the third unitary sprocket subset comprises a complementary third support structure for cooperating with the third support structure of the driver, and wherein the fourth unitary sprocket subset comprises a complementary fourth support structure for cooperating with the fourth support structure of the driver.

Optionally, the third unitary sprocket subset is free of a complementary second support structure for cooperating with the second support structure.

Optionally, the third unitary sprocket subset is configured for being supported in tangential direction by the driver via an adjacent sprocket or sprocket subset.

Optionally, the third unitary sprocket subset is configured for being supported by the driver in tangential direction with only the second support structure or only the fourth support structure.

Optionally, the third unitary sprocket subset comprises an engagement structure configured for being supported in tangential direction to an adjacent sprocket or sprocket subset so as to transfer torque to the driver via the adjacent sprocket or sprocket subset.

Optionally, the first set of sprockets has differing number of teeth including a smallest sprocket having at most 11 teeth or at most 10 teeth, and the second set of sprockets has differing number of teeth including a smallest sprocket having more than 10 teeth or more than 11 teeth.

Optionally, the system comprises an adapter configured for being releasably coupled to the driver, such that, if coupled to the driver, the adapter can support the second set of sprockets.

Optionally, the driver comprises an internal thread, and the first locking element and the second locking element each comprise a external thread complementary to the internal thread for coupling the first coupling element or the second locking element to the driver.

Optionally, the driver comprises an external thread, and the first locking element and the second locking element each comprise a internal thread complementary to the external thread for coupling the first coupling element or the second locking element to the driver.

Optionally, the first locking element and the second locking element comprises respectively a radially extending first flange and a radially extending second flange, in use when coupled to the driver extending radially with respect to the rotation axis for respectively axially abutting the first set sprockets and the second set of sprockets, and wherein a radial extent of the first flange is smaller than the radial extend of the second flange.

Optionally, the radial extent of the second flange is such that, in use when coupled to the driver, the second flange radially extends beyond the adapter.

Optionally, the first adapter includes axial splines, and the second adapter is free of axial splines.

Optionally, a coupling interface between the driver and the first adapter and between the driver and the second adapter is configured for not transferring torque from the first adapter and the second adapter in the forward drive direction.

Optionally, a coupling interface between the driver and first adapter is arranged for transferring torque from the first adapter to the driver in only a backward direction opposite the forward drive direction, and wherein a coupling interface between the driver and second adapter is arranged for neither transferring torque from the second adapter to the driver in the forward drive direction nor in the backward direction.

It will be appreciated that any of the aspects, features and options described herein can be combined. It will particularly be appreciated that any of the features and options described in view of the driver apply equally to any of the aspects, and vice versa.

### BRIEF DESCRIPTION OF THE DRAWINGS

Embodiments of the present invention will now be described in detail with reference to the accompanying drawings in which:

FIGS. 1A and 1B show an exemplary driver;

FIG. 2 shows an assembly of the driver with an exemplary adapter of a first type;

FIG. 3 shows a side view of an assemblies including a driver, an exemplary adapter of a second type and set of sprockets;

FIG. 4 shows a side view of an assemblies including a driver, an exemplary adapter of a third type and set of sprockets;

FIG. 5 shows a side view of an assemblies including a driver, an adapter of a first type and set of sprockets;

FIGS. 6-8 show exploded views of the exemplary assembly shown in FIG. 5.

### DETAILED DESCRIPTION

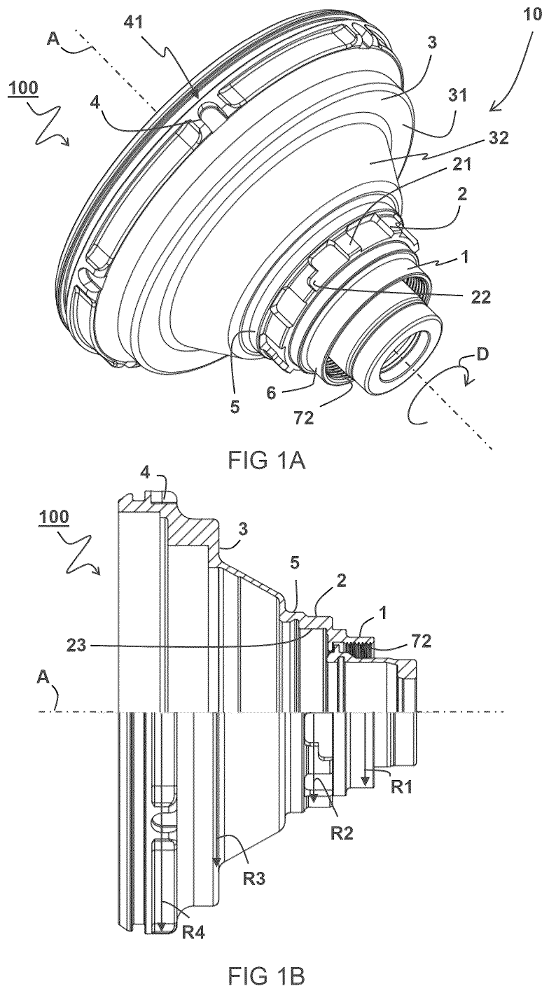

FIG. 1A shows a perspective view of a driver 100 including a coupling profile 10 for coupling a set of sprockets 50 thereto. FIG. 1B shows a side view of the driver 100, with a cut-out to show in part a cross section of the driver 100. The driver 100 is in this example substantially conically shaped for providing an internal space to accommodate an internal hub transmission. The internal hub transmission can be interconnected between the driver 100 and a wheel hub of the bicycle. The driver 100 has a rotation axis A, which in use corresponds to the rotation axis of the bicycle wheel. Herein, spatial indications such as axial, radial are generally given in relation to the rotation axis. For example, an “axial direction” used herein signifies a direction along the rotation axis A or parallel thereto, whereas a “radial direction” signifies a direction transverse to the rotation axis A, radially outward.

The coupling profile 10 is configured for supporting the set of sprockets 50 of differing number of teeth. The set of sprockets 50 can include one or more unitary subset of sprockets so fixed to each other to move monolithically. For instance, all sprockets of the set of sprockets can be formed as a unitary set of sprockets so fixed to each other to move monolithically. The coupling profile is configured for supporting the set of sprockets 50 including a smallest sprocket of the set of sprockets having at most 11 teeth, or at most 10 teeth. The coupling profile 10 is configured for supporting the set of sprockets 50, particularly in a tangential direction so that torque about the rotation axis A from the set of sprockets 50 can be transferred to the driver 100. The coupling profile 10 is furthermore configured for supporting the set of sprockets 50 in axial direction, for example to allow the set of sprockets 50 to be axially locked in a predetermined position. The coupling profile 10 is also configured to support the set of sprocket in radial direction to center and align the sprockets with respect to the rotation axis A.

The coupling profile 10 comprises a first support structure 1 configured for supporting the set of sprockets 50, particularly a smallest sprocket of the set of sprockets 50, in a radial direction. The first support profile 1 is particularly arranged for supporting the set of sprockets 50 exclusively in a radial direction. The first support profile 1 is accordingly incapable of supporting the set of sprockets 50 in the tangential direction, and hence cannot transfer torque from the set of sprockets 50 to the driver 100. The first support profile 1 is furthermore incapable of supporting the set of sprockets 50 in axial direction. In this example, the first support structure 1 is formed by an exterior surface of a smooth tubular section of the driver 100, free of splines.

The first support structure 1 is arranged at a first radius R1 from the rotation axis A. The first radius R1 is relatively small, such that the first support structure 1 is configured for supporting the smallest sprocket of the set having 11 teeth or 10 teeth. An outer diameter of the first support structure may therefore be less than 30 mm to fit such small sprocket.

The coupling profile 10, here, also comprises a second support structure 2. The second support structure 2 is configured for supporting the set of sprockets 50 in a tangential direction. Hence, torque can be transmitted from the set of sprockets 50 to the driver 100 about the rotation axis A through the second support structure 2. Hence, sprockets of the set of sprockets 50 not carried by the second support structure 2 may for example transfer torque through the second structure 2 via one or more adjacent sprockets. The second support structure 2 is also configured to support the set of sprockets 50 in a radial direction. The second support structure 2 is in this example particularly arranged for supporting the set of sprockets 50 exclusively in the tangential and the radial direction. The second support structure 2 is accordingly incapable of supporting the set of sprockets 50 in the axial direction.

The coupling profile 10, here, also comprises a third support structure 3. The third support structure 3 is configured for supporting the set of sprockets 50 in a axial direction. The third support structure 3 is in this example particularly arranged for supporting the set of sprockets 50 exclusively in the axial direction. Here, the set of sprocket is exclusively supported in the axial direction by the third support structure 3. Hence, no other support structures support the set of sprockets 50 in the axial direction. The third support structure 3 is incapable of supporting the set of sprockets 50 in the tangential direction, and hence cannot transfer torque from the set of sprockets 50 to the driver 100. The third support structure 3 is also incapable of supporting the set of sprockets 50 in the radial direction. The coupling profile 10, here, also comprises a fourth support structure 4. The fourth support structure 4 is configured for supporting the set of sprockets 50 in the tangential direction. The fourth support structure 4 is also configured for supporting the set of sprockets 50 in the radial direction. The fourth support structure 4 is in this example particularly arranged for supporting the set of sprockets 50 exclusively in the tangential and radial direction. Hence, here, the fourth support structure 4 is incapable of supporting the set of sprockets 50 in the axial direction, and is hence not used for axially locking the set of sprockets 50.

The first, second, third and fourth support structures 1-4 are arranged at different radii from the rotation axis A. The first support structure 1 is arranged at a first radius R1 from the rotation axis. The second support structure 2 is arranged at a second radius R2 from the rotation axis A, larger than the first radius R1. The third support structure 3 is arranged at a third radius R3 from the rotation axis A, larger than the second radius R2. The fourth support structure 1 is arranged at a fourth radius R4 from the rotation axis A larger than the third radius R3.

The first, second, third and fourth support structures 1-4 are spaced in axial direction from each other in this example. Here, the first support structure 1 is axially positioned at a drive side end of the driver 100. The second support structure 2 is axially positioned offset towards the non-drive side relative to the first support structure 1. The third support structure 3 is axially positioned offset towards the non-drive side relative to the second support structure 2. The fourth support structure 4 is axially positioned offset towards the non-drive side relative to the third support structure 3. Here, the fourth support structure is axially positioned near a non-drive side end of the driver 100.

Here, the first support structure 1 is formed by tubular section of the driver 100, with a smooth exterior. The first support structure 1 is accordingly free of splines. An interior of the tubular section, here, includes an internal thread for cooperating with complementary thread of a locking element 70. The locking element 70 can hence be threadingly coupled to the driver 100, thereby axially locking the set of sprockets 50.

Generally, the driver 100 is supported onto a wheel axle by one or more bearings, such as roller bearings. The driver 100 thereto comprises one or more bearing mounting surfaces for mounting the one or more bearings to the driver 100. The one or more bearing mounting surfaces can each include an internal cylindrical surface of the driver 100. As can be seen in FIG. 1B, the first support structure 1 is positioned axially offset from the drive side bearing mounting surface 23. towards the drive side. Also, as can be seen in FIG. 1B, here the first outer radius R1 is smaller than an inner radius of the drive side bearing mounting surface 23. It can be seen that the internal diameter of the thread of the tubular section of the first support structure 1 has a smaller diameter than the drive side bearing mounting surface 23. It will be clear that, the first support structure 1 having an inner diameter smaller than the drive side bearing mounting surface 23, the drive side bearing must be mounted from the non-drive side.

Here, the second support structure 2 comprises axial splines 21 extending lengthwise parallel to the rotation axis A. A smallest radius of the second support structure 2, here at the base of the axial splines 21, is larger than the first outer radius R1. More in general, the smallest outer radius at the axial location of the second support structure 2 is larger than the first outer radius R1. As can be seen in FIG. 1B, the second support structure 2 axially positioned at the location of the drive side bearing mounting surface 23. Here, the smallest outer radius of the second support structure 2 is larger than the inner radius of the drive side bearing mounting surface 23. The axial splines 21 extend lengthwise from a first end proximate the first support structure 1 to a second end distal to the first support structure 1, here proximate the third support structure 3. Each of the axial splines 21 include a drive side and a non-drive side. In use when the bicycle is forwardly driven by a user, torque is transferred from the set of sprockets 50, via the driver to the bicycle wheel, thereby tangentially loading the drive side of the axial splines 21. As bicycles are generally not driven in reverse, little to no torque needs to be transferred through the non-drive side of the axial splines 21 in practice. Some bicycles for example include a freewheel mechanism between the bicycle wheel and the driver, to allow the driver to be rotated backwards without transferring torque to the bicycle wheel. Hence, the non-drive side of the axial splines 21 is loaded less frequent, and to lesser extent than the drive side.

Some of the axial splines 21 are wider at the second end than at the first end. In particular, here, the one or more of the axial splines 21 are recessed at an axial end. The recess 22 is arranged for accommodating a complementary projection, such as a projection of an adapter that can be releasably coupled to the driver 100. In particular, the recess 22 is arranged at the non-drive side of the axial splines 21. Hence, in this example, the drive side of the axial splines 21 includes a straight abutment surface that faces in a tangentially forward drive direction of the driver, indicated by arrow D, and the non-drive side of at least some of the axial splines 21 include a stepped abutment surface that generally face in a tangentially backward direction. In this example, every second spline is recessed, but other configurations are also envisioned.

The third support structure 3, here, is free of splines. The third support structure 3 includes an axial abutment surface 31, here shaped as an annulus. The third support structure 3, here, is axially positioned axially offset towards the non-drive side relative to the drive side bearing mounting surface 23. The axial abutment surface 31 is configured for axially abutting the set of sprockets 50, particularly a sprocket that is neither the largest nor the smallest sprocket of the set. The third support structure 3 is in this example the only axial support for the set of sprockets 50. Hence, the set of sprockets 50 can be axially clamped between the axial abutment surface 31 and the locking element 70, obtaining a reliable mechanically determinate arrangement.

The third support structure 3 in this example comprises a conical section 32 proximate the second support structure and diverging towards the fourth support structure, and a cylindrical section 33 proximate the fourth support structure. The cylindrical section 33 and the conical section 32 are interconnected by the axial abutment surface 31.

The fourth support structure 3, here, comprises multiple pairs of splines 41. Each pair 41 of splines includes two splines that are spaced apart from each other to define a spacing for accommodating a compensatory support structure of the set or sprockets. The fourth support structure 4, here, is axially positioned axially offset towards the non-drive side relative to the third support structure 3. The fourth support structure is particularly arranged for supporting one or more of the largest sprockets of the set. The pairs of splines 41 are in this example sparsely distributed around the rotation axis A at even intervals, particularly such that a the intervals between adjacent pairs are greater than the spacing between the splines of a pair.

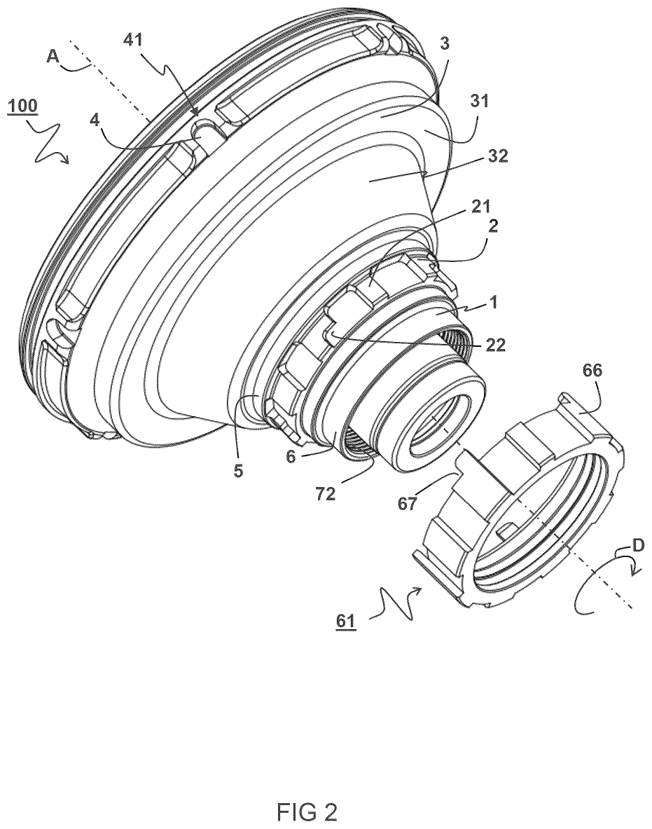

FIG. 2 shows a perspective view of the driver 100 as shown in FIG. 1A, and an exemplary adapter for being releasable coupled to the driver 100. The adapter in this example is an adapter of a first type 61, here comprising axial splines 66. The adapter of the first type 61 is radially supported by the first support structure 1. The adapter of the first type 61 and the driver 100 are so configured that the axial splines 21 of the adapter of the first type 61 and the axial splines 21 of the second support structure 2 respectively align when the adapter of the first type 61 is coupled to the driver 100. In this example, the adapter of the first type 61 comprises projections 67 for respectively mating with the recesses 22 of the axial splines 21 of the second support structure 2. The adapter of the first type 61 hence can hence extend the second support structure in axial direction. As the recesses 22 of the axial splines 21 and the projections 67 of the adapter of the first type 61 are arranged at a non-drive side of the axial splines 21, the adapter of the first type 61 is not configured to transfer torque to the driver 100 in the forward drive direction D. Accordingly, sprockets of the set radially supported by the adapter of the first type 61, will in use not transfer torque to the driver 100 via the adapter of the first type 61. Instead, the sprockets of the set radially supported by the adapter of the first type 61 are tangentially supported by the second support structure. Hence, these sprockets can in use transfer torque through the second support structure 2 to the driver 100 via adjacent sprockets. The set of sprockets 50 may hence, for example, be so adapted to the driver 100 and the adapter of the first type 61, that multiple sprockets of the set form a unitary sprocket subset configured to move monolithically. In particular example, the set of sprockets 50 may be entirely unitary. The set of sprockets 50 may hence be formed as a single piece, to move monolithically. Some sprockets of the set may however be separate from each other, and coupled to each other when coupled to the driver 100. Adjacent separate sprockets or unitary sprocket subsets may for example be releasably coupled to each other when supported by the driver 100, such that torque can be transferred to the driver 100 via the adjacently coupled sprocket or unitary sprocket subset.

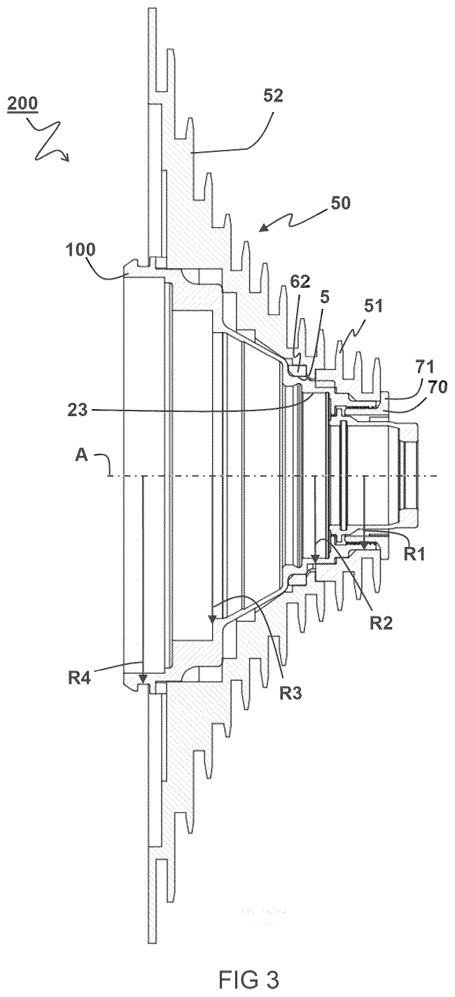

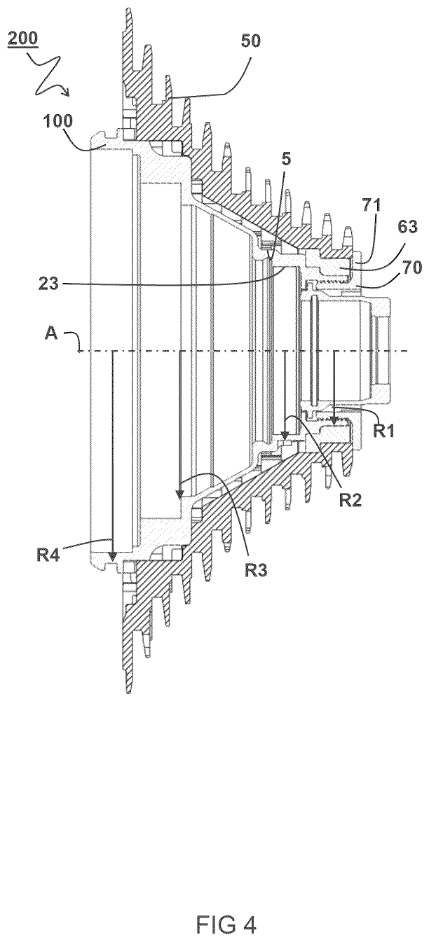

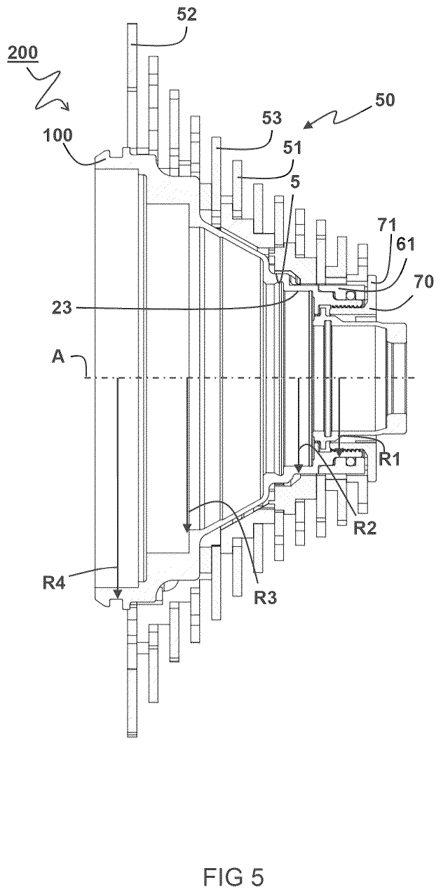

FIGS. 3-5 show a cross sectional side view of an assembly 200 including a driver 100 and respective sets of sprockets supported by the driver 100. In FIGS. 4 and 5, the driver 100 is coupled to an adapter. In the example of FIG. 5 the adapter is of the first type 61 as shown in FIG. 2, in the example of FIG. 3, the adapter is of a second type 62, and in the example of FIG. 4 the adapter is of a third type 63. The set of sprockets 50 is at least partly supported by the adapter. However, it will be clear that also embodiment are conceived in which no adapter is used.

In the example of FIG. 3, the set of sprockets 50 includes two unitary sprocket subsets. A first unitary sprocket subset 51 includes the smallest sprockets of the set, in this example three sprockets including respectively ten teeth, eleven teeth and twelve teeth. A second unitary sprocket subset 52 includes the largest sprockets of the set, here including ten sprockets. In the example of FIG. 3, the assembly includes an adapter, here an adapter of a second type 62. The adapter of the second type 62 radially supports the set of sprockets 50 radially. The adapter of the second type 62 is ring shaped, and has a smooth radial inner surface for contacting a smooth cylindrical adapter support surface 5 of the driver 100, here being a portion of second support structure 2 proximate the third support structure 3. The adapter of the second type 62 has a smooth radial outer surface for contacting the set of sprockets 50. Here, the second unitary sprocket subset 51 is radially supported by the adapter support surface 5 of the driver 100 via the adapter of the second type 62.

The first unitary sprocket subset 51 is tangentially supported by the second support structure 2. Hence, torque can be transferred from the first unitary sprocket subset 51 to the driver 100 through the second support structure 2, not through the first support structure 1. The second unitary sprocket subset 52 is tangentially supported by the fourth support structure 4. The second unitary sprocket subset 52 is in this example not tangentially supported by the second support structure 2, particularly because the adapter of the second type 62 is not tangentially supported by the second support structure 2 of the driver 100. Hence, in use, torque is transmitted from the second unitary subset 52 to the driver 100 through the fourth support structure 4, not the second support structure 2. The second unitary sprocket subset 52 is axially supported by the third support structure 3, here by abutting the axial abutment surface 31. The first unitary sprocket subset 51 is also axially supported by the third support structure 3, by axially abutting the second unitary sprocket subset 52. Here, the assembly 200 also comprises a spacer. The spacer is arranged to radially support the set of sprockets 50, here particularly the second unitary sprocket subset 52, in this example near the second support structure.

In the example of FIG. 4, the set of sprockets 50 is formed by a single unitary subset of sprockets 50. Here, the entire set of sprockets 50 is machined from a single piece of material. The set of sprockets 50 in this example includes a smallest sprocket having twelve teeth. The set of sprockets 50 is radially supported by the first support structure 1, here via an adapter. The adapter in this example is an adapter of a third type 63, which is ring shaped, and has a smooth radial inner surface for contacting the first support structure, and a smooth radial outer surface for contacting the set of sprockets 50. The adapter of the third type 63 extends the first support structure 1 in radial direction, for supporting sprockets at a larger radius from the rotation axis A. The adapter of the third type 63 can be omitted for enabling support of sprockets with the first support structure 1 at a smaller radius from the rotation axis A, particularly for supporting smaller sprockets, e.g. a ten-teeth sprocket.

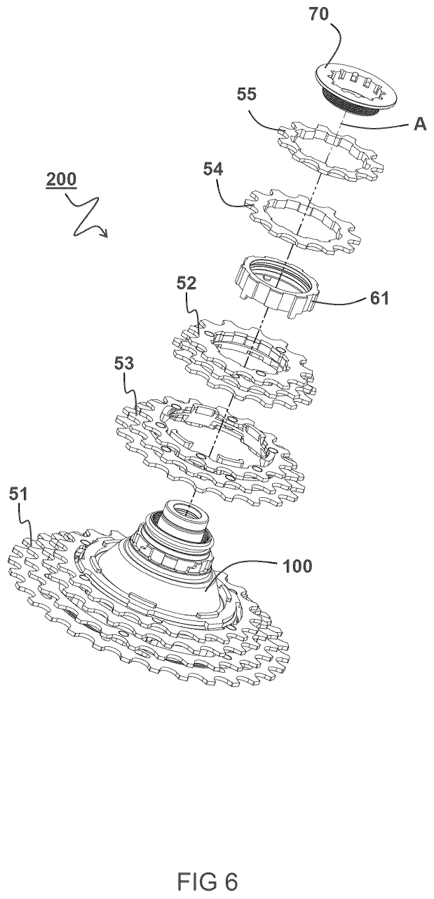

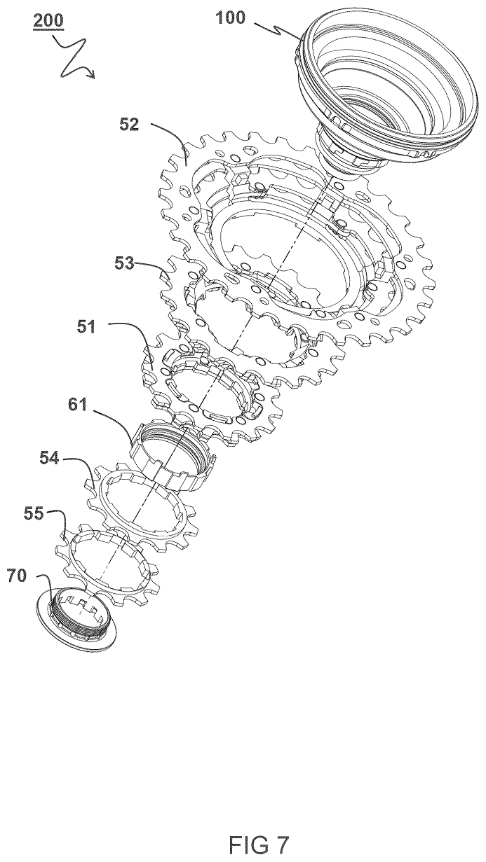

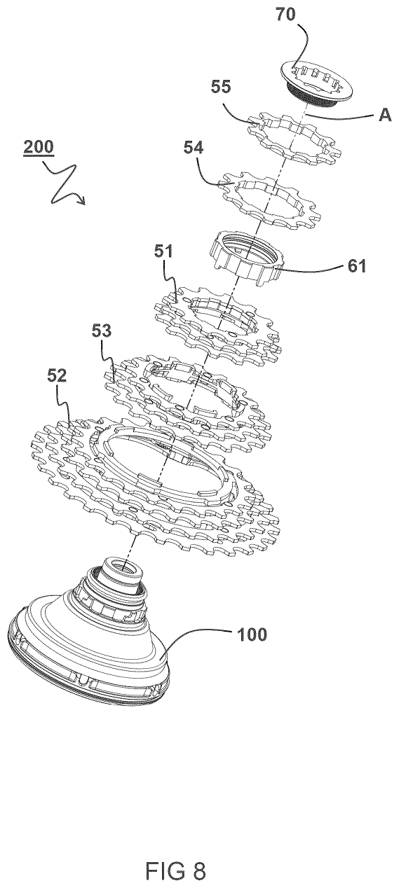

The first support structure does not support the adapter of the third type 63 and in turn the set of sprockets 50 tangentially, and hence does not transfer torque in the forward drive direction D to the driver 100. Instead, the set of sprockets 50 is exclusively tangentially supported by the fourth support structure. The set of sprockets 50 is not tangentially supported by the seconds support structure 2, even though the set of sprockets 50 overlaps the second support structure 2. Hence, in this example, torque is transferred from the set of sprockets 50 to the driver exclusively through the fourth support structure 4. The set of sprockets 50 is furthermore exclusively axially supported by the third support structure 3. In the example of FIG. 5, the set of sprockets 50 includes three unitary subsets of sprockets, namely a first unitary sprocket subset 51, a second unitary sprocket subset 52, and a third unitary sprocket subset 53. The three unitary sprocket subsets combined include the, here ten, largest sprockets of the set of sprockets 50. Here, the second unitary sprocket subset 52 includes four sprockets, here the four largest sprockets of the set, and the first and the third unitary sprocket subset 51, 53 include three sprockets each. The, here two, smallest sprockets 54, 55 of the set are separate sprockets. FIGS. 6-8 show exploded views of the assembly 200 shown in FIG. 5.

In this example, the first support structure 1 radially supports the adapter, which in turn radially supports the two smallest sprockets. The smallest sprocket and the second smallest sprockets of the set are thus radially supported by the first support structure 1 of the driver 100. The third smallest sprocket, which in this example is part of a unitary sprocket subset, is tangentially supported by the second support structure 2. In particular, the third smallest sprocket of the set is supported by the axial splines 21 of the second support structure 2, at the recessed axial end of the axial splines 21 where the axial splines 21 of the driver 100 overlap with the splines of the adapter of the first type 61. Accordingly, the adapter of the first type 61 can transfer torque to the third smallest sprocket, which in turn can be transmitted to the second support structure. The smallest and second smallest sprocket coupled to the splines of the adapter are hence tangentially supported by the second support structure 2 via the third smallest sprocket.

The second unitary sprocket subset 52 is in this example tangentially supported by the fourth support structure 4, here via the first unitary sprocket subset 51. Hereto, in this example, the first unitary sprocket subset 51 and the second unitary sprocket subset 52 include complementary engagement structures configured for enabling torque to be transferred from the second unitary sprocket subset 52 to the first unitary sprocket subset 51. The third unitary sprocket subset 53 is tangentially supported by the second support structure.

FIGS. 3-5 show the assembly 200 to comprise a locking element 70 to axially lock the set of sprockets 50. The locking element 70 threadingly couples to the driver 100, particularly by threading into the internal thread 72 at of the tubular section of the driver 100. The internal thread 72 of the driver 100 in this example overlaps with the first support structure 1 in axial direction, i.e. an axial extent of the internal thread 72 and an axial extent of the first support structure 1 are overlapping such that, if seen in radial direction, the first support structure 1 is at least partly behind the internal thread 72 or vice versa. The internal thread 72 may hence be arranged radially inside of the tubular section 6 of the drive r100 while the first support structure 1 is arranged on a radial outside of the tubular section 6. The driver 100, particularly the tubular section 6, may hence in use be arranged radially between the locking element 70 and the set of sprockets 50.

Alternatively, the driver may include an external thread, and the locking element 70 may include an internal thread. The locking element 70 may hence be arranged radially outside of the driver 100, such that a radially outer surface of the locking element 70 can carry the set of sprockets, particularly one of more of the smallest sprockets of the set. The locking element 70 can hence form the first support structure 1, for supporting the set of sprockets only in a radial direction. In such alternative arrangement, the external thread of the driver 100 is arranged on the radial outside of the tubular section 6, such that, in use, the locking element 70 is arranged between the driver 100, particularly the tubular section 6, and the set of sprockets 50. The set of sprockets may hence be radially supported by the locking element 70.

The locking element 70 has a radially extending flange 71 that in use extends radially to the rotation axis A. The flange 71 axially abuts the set of sprockets 50 to clamp the set of sprockets 50 axially between the flange 71 and the third support structure 3. The locking element 70 of the example shown in FIG. 3 is different from the locking element 70 of the example shown in FIGS. 4 and 5. In particular, the locking element 70 shown in FIG. 3 as a flange 71 with a smaller radial extent than the locking element 70 shown in FIGS. 4 and 5. In the example of FIGS. 4 and 5, the flange 71 radially extends beyond respectively the adapter of the third type 63 and the adapter of the first type 61 for engaging the smallest sprocket of the set. In the example of FIG. 3, the assembly 200 does not include an adapter supported by the first support structure 1, such that the radial extent of the flange 71 can be decreased for engaging the smallest, ten-teeth, sprocket of the set.

In an example, the driver 100 may be coupled to a belt pully for driving a belt. The belt pully may be supported tangentially by the second support structure 2.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A driver for transferring torque from a set of sprockets of differing number of teeth to a wheel of a bicycle, the driver having a rotation axis and comprising a coupling profile for coupling the set of sprockets thereto, wherein the coupling profile includes:
a first support structure at a first outer radius from the rotation axis, configured for carrying a smallest sprocket of the set of sprockets and supporting the set of sprockets in only a radial direction and/or an axial direction, and
a further support structure, spaced in axial direction from the first support structure, wherein a smallest outer radius from the rotation axis at an axial location of the further support structure is larger than the first outer radius, the further support structure being configured for supporting the set of sprockets in a tangential direction.

2. The driver of claim 1, wherein the first support structure has an outer diameter of less than 32 mm, such as between 25 and 32 mm, preferably between 27 mm and 31 mm, more preferably approximately 30 mm.

3. The driver of claim 1, wherein the smallest sprocket has at most 11 teeth, or at most 10 teeth.

4. The driver of claim 1, wherein the first support structure is free of splines.

5. The driver of claim 1, wherein the first support structure is arranged at an axial end of the driver, and wherein the driver at the axial end comprises an internal thread for cooperating with a complementary thread of a locking element.

6. The driver of claim 1, wherein the smallest sprocket together with a second smallest sprocket, and optionally a third smallest sprocket, of the set of sprockets forms a unitary subset of sprockets so fixed to each other to move monolithically.

7. The driver of claim 1, wherein the further support structure includes, or is, a second support structure at a second outer radius from the rotation axis larger than the first outer radius, wherein the second support structure is configured for supporting the set of sprockets in a tangential direction and optionally a radial direction.

8. The driver of claim 7, wherein the second support structure comprises axial splines, each extending lengthwise parallel to the rotation axis.

9. The driver of claim 8, wherein the axial splines extend lengthwise from a first end proximate the first support structure to a second end distal to the first support structure, and wherein one or more of the axial splines have a first width at the first end and a second width at the second end, the first width being smaller than the second width.

10. The driver of claim 8, wherein a lengthwise dimension of the axial splines is at most 10 mm, preferably in a range between 1 and 8 mm, more preferably in a range between 3 and 6 mm.

11. The driver of claim 7, wherein the further support structure includes, or is, a third support structure at a third outer radius from the rotation axis, larger than the first outer radius, and larger than the second outer radius, configured for supporting a sprocket of the set of sprockets in an axial direction.

12. The driver of claim 11, wherein the coupling profile is configured to only support the set of sprockets in the axial direction with the third support structure, e.g. using an axial abutment surface, which is preferably annular shaped and coaxial with the rotation axis.

13. The driver of claim 11, wherein the further support structure includes, or is, a fourth support structure at a fourth outer radius from the rotation axis, larger than the first outer radius, and larger than the second outer radius and the third outer radius, configured for supporting a sprocket of the set of sprockets in only the radial direction and a tangential direction.

14. The driver of claim 13, wherein the fourth support structure comprises a plurality of axial spline pairs, and splines of each pair being angularly spaced apart for accommodating a complementary support structure of a sprocket, wherein the plurality of axial spline pairs are angularly spaced apart by a distance larger than angular spacing between the splines of the plurality of axial spine pairs.

15-17. (canceled)

18. An assembly comprising a driver for transferring torque from a set of sprockets to a wheel of a bicycle, the driver having a rotation axis and comprising a coupling profile for coupling the set of sprockets thereto, wherein the coupling profile includes a first adapter support surface configured for supporting a first adapter in a radial direction and a second adapter support surface configured for supporting a second adapter in, e.g. only, a radial direction,
wherein the first adapter support surface is at a smaller radius from the rotation axis than the second adapter support surface,
wherein the assembly in a first configuration comprises the first adapter supported by the first adapter support surface and is configured for supporting a first set of sprockets, and wherein the assembly in a second configuration comprises the second adapter supported by the second adapter support surface and is configured for supporting a second set of sprockets different from the first set of sprockets.

19. (canceled)

20. An assembly comprising a driver for transferring torque in a forward drive direction from a set of sprockets with differing number of teeth to a wheel of a bicycle, and an adapter for being coupled to the driver,
the driver comprising a rotation axis and a coupling profile having a second support structure with second axial splines configured for supporting the set of sprockets in at least a tangential direction; and
the adapter releasably coupled to the driver, and including first axial splines,
wherein a coupling interface between the driver and the adapter is configured such that, in a coupled state, the first axial splines and the second axial splines are respectively aligned.

21. The assembly of claim 20, wherein the coupling interface between the driver and the adapter is arranged for providing a form-closed coupling between the driver and the adapter.

22. The assembly of claim 21, wherein the coupling interface between the driver and the adapter is configured for transferring torque from the adapter to the driver in only one rotation direction about the rotation axis, in particular only in a backward direction of the driver, e.g. a freewheel direction, opposite the forward drive direction.

23. The assembly of claim 21, wherein the coupling profile comprises a first support structure at a smaller outer radius from the rotation axis than the second support structure, the first support structure being configured for supporting the set of sprockets, particularly a smallest sprocket of the set of sprockets, in only a radial direction.

24. (canceled)

25. A set of sprockets comprising a plurality of sprockets with differing numbers of teeth configured for being supported by the driver in accordance with claim 1.

26. The set of claim 25, comprising a complementary first support structure at the first outer radius from the rotation axis for cooperating with the first support structure of the driver, and/or a complementary second support structure at a second outer radius from the rotation axis for cooperating with the further support structure of the driver, and/or a complementary third support structure at a third radius from the rotation axis for cooperating with a third support structure, and/or a complementary fourth support structure at a fourth radius from the rotation axis for cooperating with a fourth support structure.

27. The set of claim 26, comprising a first unitary sprocket subset and a second unitary sprocket subset each including a respective multiple of sprockets being so fixed to one another to move monolithically,
wherein the first unitary sprocket subset comprises a complementary first support structure for cooperating with the first support structure of the driver, and a complementary second support structure for cooperating with the second support structure of the driver, and
wherein the second unitary sprocket subset comprises a complementary second support structure for cooperating with the second support structure of the driver, and a complementary third support structure configured for cooperating with the third support structure of the driver, and/or a complementary fourth support structure configured for cooperating with the fourth support structure of the driver.

28. The driver of claim 1,
wherein the driver is configured to in a first configuration couple to a first locking element to thereby axially engage a smallest sprocket of the first set of sprockets to axially lock the first set of sprockets, and
wherein the driver is configured to in a second configuration couple to a second locking element, different from the first locking element, to thereby engage a smallest sprocket of a second, different, set of sprockets to axially lock the second set of sprockets.

29. The driver of claim 28, wherein the first set of sprockets has differing number of teeth including a smallest sprocket having at most
